(19) United States
(12) Patent Application Publication
(10) Pub. No.: US 2006/0172028 A1
(43) Pub. Date: Aug. 3, 2006

(54) Quick change head tooling for blow molding machine

(75) Inventors: Anthony C. Arruda, Ann Arbor, MI (US); Donald Drake, Saline, MI (US); Mark A. Harris, Dexter, MI (US); Richard A. Knaggs, Ottawa Lake, MI (US); David R. Koller, Saline, MI (US)

Correspondence Address: DICKINSON WRIGHT PLLC, 1901 L. STREET NW, SUITE 800, WASHINGTON, DC, 20036, US

(73) Assignee: Visteon Global Technologies, Inc.

(21) Appl. No.: 11/048,222

(22) Filed: Feb. 1, 2005

(51) Int. Cl. B29C 49/00

(52) U.S. Cl. 425/182; 425/532; 425/192 R

(57) ABSTRACT

A blow molding machine having a tool head that is quickly and efficiently interchanged to minimize the time required to switch between products being blow molded. The tool head is changed without the need for removing the heater bands and with minimal need for alignment during installation.

### BACKGROUND OF THE INVENTION

The present invention is directed to a die assembly for a blow molding machine and, more specifically, to a die assembly having a tool head that is quickly and efficiently interchanged to minimize the time required to switch between products being blow molded.

Blow molding machines are generally used to make thermoplastic containers and parts, such as fuel tanks for vehicles. In operation, blow molding machines typically extrude an elongated parisan between an inner ring and an outer ring on the tool head. To form a container, such as a vehicle fuel tank, a large die is clamped around the parisan while the extruded parisan is still partially molten. The parisan is then injected with air or an inert gas causing the parisan to expand and conform to the shape of the die. The shape, configuration, size, and relative arrangement of the inner and outer rings set the wall thickness, diameter, and shape of the extruded parisan. The shape, wall thickness, and diameter of the parisan are important because the parisan must be capable of being blown into the final shape. For example, certain portions of the parisan expand a greater distance, such as the portions that expand to the comers of the container. Further, if any portion of the container requires additional reinforcements, the shape, size, and wall thickness of the parisan may also vary to provide extra material where the reinforcements are needed. Problems may occur if upon expansion into a container, the wall thickness of the container is too thin. Conversely, problems may also occur if the container's walls are too thick in addition to raising manufacturing costs through material wastage and slower extrusion times.

One problem with most blow molding machines is that changing the tool head of the die assembly to provide different shaped parisans for forming different shaped containers is time consuming. For example, in some circumstances, changing the tool head to switch between fuel tanks made for different automobiles causes the manufacturing line to be shut down for long periods of time. Blow molding machines operate at high temperatures to form the molten parisan and head tooling must be changed at operating temperatures, to prevent the material in the head tooling from hardening. If the material hardens before or while changing, it is difficult to disassemble and change the head tooling. Existing blow molding machines generally include at least two heater bands 110 around the die assembly, as illustrated in FIG. 1. Before the head tooling may be completely removed, the heater bands 110 have to be removed, which may require skilled trade support to accomplish. The availability of the tradesman may be problematic depending on current work loads of the required tradesman. With the heater bands removed, the die assembly, including the tool head having an inner and outer ring 60, 90, is removed and cleaned while hot. Generally, the components must be removed in a specified order until the exemplary portion illustrated in FIG. 1 by line A-A is removed. The tool head when removed typically weighs 300 to 500 pounds, thereby requiring multiple people to loosen the individual components and special lifts to support the tool head as it is being removed. After the tool head is removed, the new tool head is assembled and attached to the molding machine by assembling the individual components and attaching the tool head to the die assembly using special lifts. Once the new tool head is attached, the inner die ring and the outer die ring must be centered and aligned relative to each other. Centering and aligning of the inner and outer rings is a lengthy, tedious and difficult process that is further complicated when one or both of the inner and outer rings 60, 90 include scallops, contours or other non-cylindrical shapes. More specifically, the inner and outer die rings must be aligned both rotationally about the axis of the blow molding machine as well as laterally and longitudinally. After the new tool head is installed with the inner and outer rings, the heater bands 110 are installed and connected to preheat the head tooling to operating temperature. Due to the mass of the die assembly and associated components of the blow molding machine, a significant amount of time is generally required to reach operational temperature. Due to variances related to temperature and the extrusion process, the final alignment is performed by qualified personnel while material is being extruded through the head tooling. A significant problem with the above process is that any alignment problems of the inner ring 60 or outer ring 90 may not be evident until the machine produces products that do not meet required specifications.

The process for changing tool heads is complicated, lengthy and to avoid down time due to head tool changes, some manufacturers purchase extra blow molding machines and create additional assembly lines to avoid a loss of production while tool heads are being changed. Other manufacturers, to avoid the significant capital expenditure of additional machines, design multi-use tool heads that are capable of forming a variety of acceptable containers or products therefore typically the machine adversely affects the machine runtime. The problem with multi-use tool heads that they produce differing containers or product and generally prevent maximum performance of the tool head in forming any one container or one product. For example, in a container formed from a tool head capable of forming multiple containers, the formed container generally has heavier walls than needed in certain areas, thereby, adding to the weight of the container and wasting material used to form the container.

In view of the above problems and limitations, there is a need in the art for a quick change blow molding die assembly and tool head which allows easy and efficient changes of the tool head to accommodate various containers without significant down time.

### SUMMARY OF THE INVENTION

The present invention is directed to a die assembly for a blow molding machine and, more specifically, to a die assembly having a tool head that is quickly and efficiently interchanged to minimize the time required to switch between products being blow molded. More specifically, in a first embodiment, the present invention is directed to a tool head for a blow molding machine having a die ring, an outer ring and a retaining ring. The die ring has a lower die edge, an outer die surface, and an inner die surface. The outer ring has an outer profiled surface and a lower ring surface, wherein the outer profiled surface engages the inner die surface and the retaining ring engages the lower die edge and the lower ring surface. A heater coil is coupled to the die ring so that the retaining ring and the outer ring are removable from said die ring without removing the heater coil.

In a second embodiment, the present invention is directed to a tool head having a die ring, an outer ring and at least one heater coil coupled to said die ring. The die ring is substantially located between the heater coil and the outer ring. More specifically, the outer ring may be removed from said die ring without removing said heater coil. The retaining ring couples the outer ring to the die ring, with the retaining ring engaging a lower die surface of the die ring and a lower ring surface on the outer ring.

In a third embodiment, the tool head includes a die ring, an outer ring coupled to the die ring, and an outer key assembly for rotationally aligning the outer ring with the die ring. The tool head further includes a die pin and an inner ring coupled to the die pin. The die pin and the inner ring include an inner key assembly for rotationally aligning the inner ring relative to the outer ring, with the inner ring and the outer ring defining an extrusion gap therebetween.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a prior art sectional view of a tool head for a blow molding machine;

FIG. 2 is a sectional view of a tool head;

FIG. 3 is a sectional view of an alternative embodiment;

FIG. 4 is an exploded view of the tool head;

FIG. 5 is a bottom plan view of the tool head; and

FIG. 6 is a bottom plan view of an alternative embodiment.

### DETAILED DESCRIPTION OF THE PREFERRED EMBODIMENT

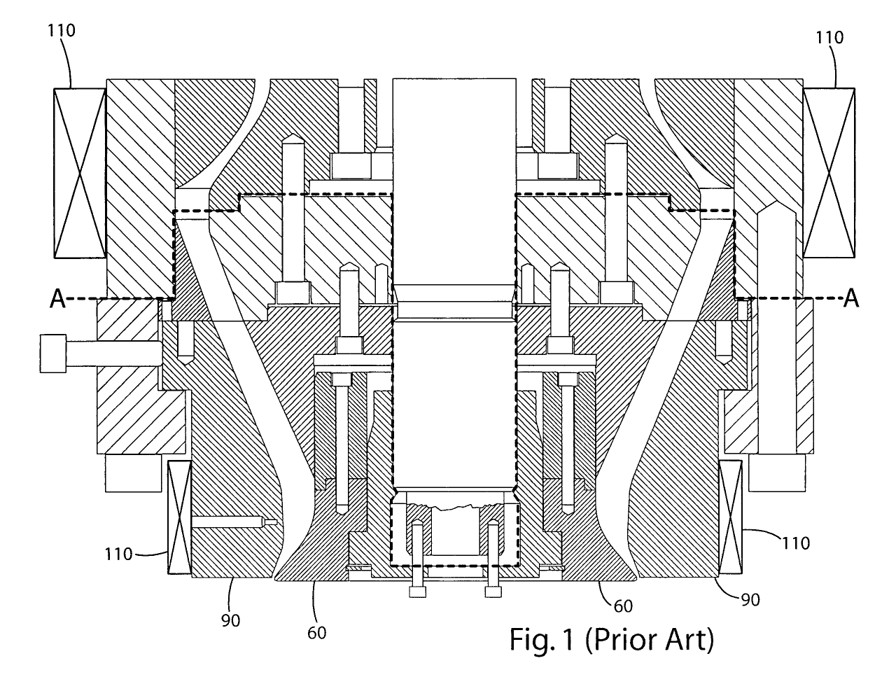

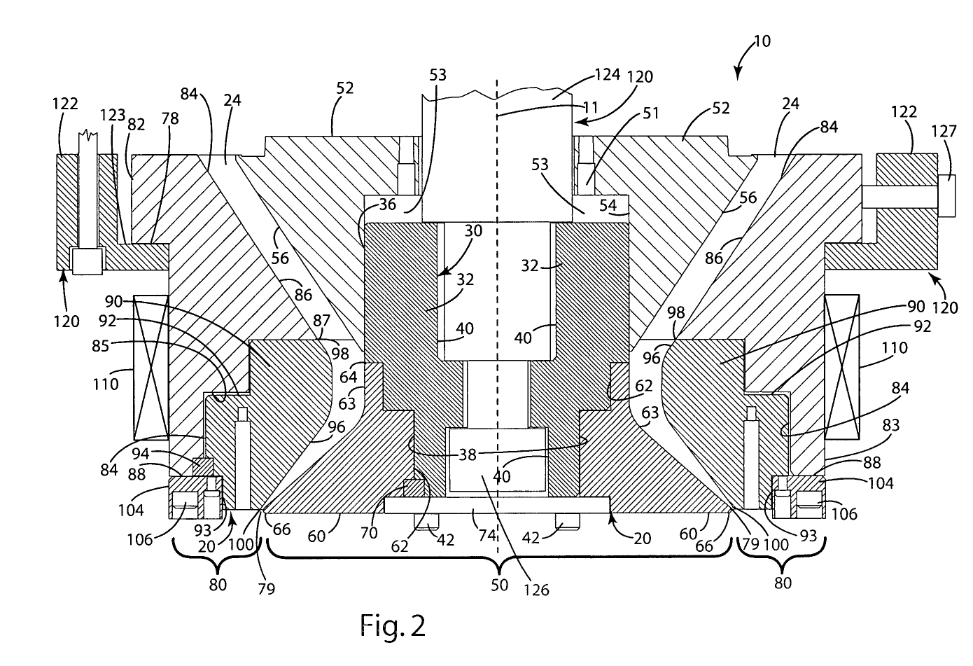

A die assembly 10 for a blow molding machine (not shown) constructed in accordance with the present invention is illustrated in FIG. 2. In general, the die assembly 10 includes a removable tool head 20 having an inner assembly 50 and an outer assembly 80 aligned along an axis 11 and defining a gap 79 therebetween. Heater coils 110 surround the die assembly 10 to heat the die assembly 10 to operational temperature so that the material in the die assembly 10 is heated until it is molten and forms a parisan that is extruded from the gap 79 between the inner and outer assemblies 50, 80. A support assembly 120 (partially illustrated in FIGS. 1 and 2) secures the die assembly 10 including the head tooling 20 to a blow molding machine (not shown).

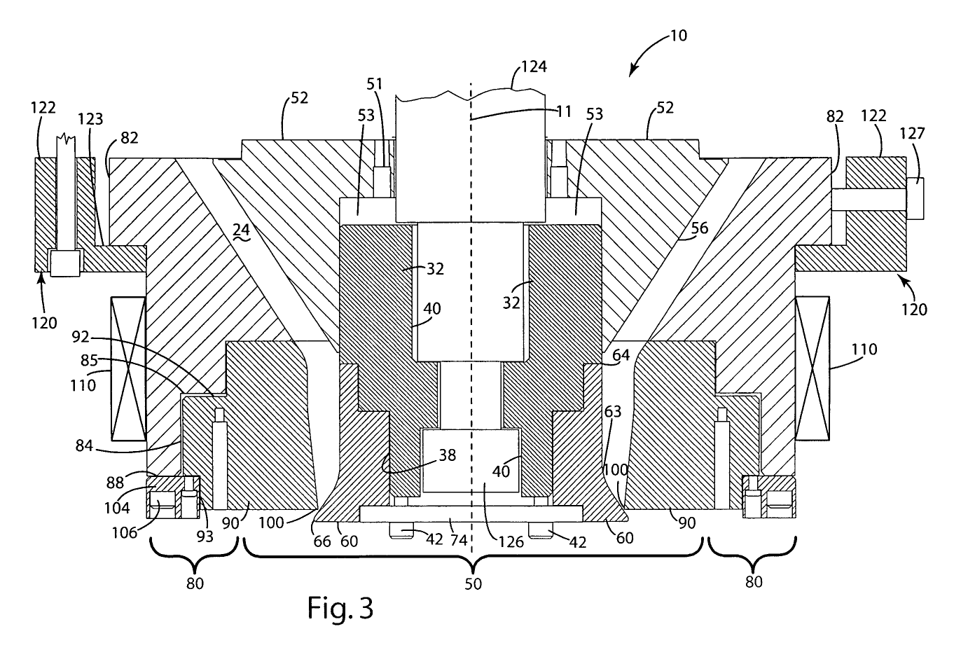

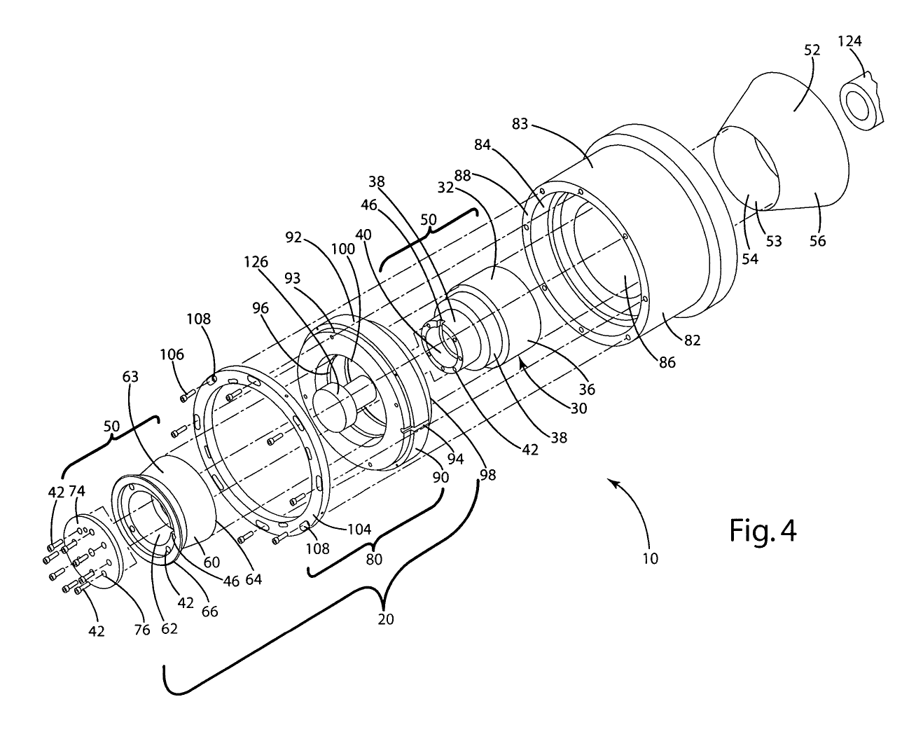

The support assembly generally includes a die assembly retaining ring 122 and a die rod 124. The die assembly retaining ring 122 supports the outer assembly 80 (FIG. 2) to the blow molding machine. The die rod 124 supports the inner assembly 50 (FIG. 2). The die assembly retaining ring 122 may be formed in a variety of shapes and configurations, but in the illustrated embodiment is a ring with an “L-shaped” sectional view in which a lower support surface 123 supports a die ring support surface 78. The die assembly retaining ring 122 may also be made with key slots (not shown) for easy removal for cleaning of the blow molding machine. However, during changing of the head tooling 10, the die assembly ring 122 remains coupled to the blow molding machine, thereby keeping the die ring 82 coupled to the blow molding machine. An adjustment mechanism 127 may be included on the die assembly ring 122, however, this generally does not need to be adjusted during changes of the head tooling. By not changing the die ring 82 with the tooling head 10, the die ring 82 does not need to be adjusted relative to the blow molding machine 10. As shown in FIGS. 2-3, the die rod 124 is coupled to a die pin 32 which is in turn coupled directly or indirectly to the inner assembly 50. In the illustrated embodiment, the die pin 32 is bolted to the die rod 124 with a die rod bolt 126. The die pin 32 is secured from movement relative to the die rod 124. The die pin 32 includes an upper pin outer surface 36, a lower pin outer surface 38, and an inner pin surface 40. The lower pin outer surface 38 is configured to receive and locate the inner assembly 50. The size, shape, and configuration of the lower outer surface 38 may vary depending on the desired configuration of the inner assembly 50 and the overall die assembly 10. The inner assembly 50 may be aligned relative to the die pin 32 through a die pin key assembly 46, as illustrated in FIG. 4. The key assembly 46 may include a removable key. The inner pin surface 40 is configured to receive the die rod 124 and couple the die pin 32 to the die rod 124. Portions of the die rod 124 are generally configured to mate with the inner pin surface 40. The die pin 32 supports the inner assembly 50 and couples the inner assembly 50 to the die rod 124. The size, shape, and configuration of the die pin 32 and the inner pin surface 40 may vary depending on the application. A lower pin fastener assembly 42 may couple the inner assembly 50 to the die pin 32.

The die assembly 10 further includes a receiver 52 for partially defining a flow path for the material and defining a cavity 53 for receiving the die pin 32 and die rod 124. The receiver 52 is generally fastened to the blow molding machine with an upper pin fastening assembly (not shown). The upper pin fastener assembly locates the position of the receiver 52 and secures the receiver 52 from movement relative to the blow molding machine and the die ring 82. The upper pin fastener assembly passes through holes 51 defined by the receiver 52. In the illustrated embodiment, the receiver 52 is generally not changed as part of the change in tool heads 20 and therefore once the receiver 52 is set and aligned, changing of the tool head 20 will not require changing of the receiver 52 or alignment of the tool head 20. As illustrated in FIG. 2, the receiver 52 is formed in somewhat of a frustoconical shape with a hollow center that forms the cavity 53. The receiver 52 includes an inner receiver surface 54 configured to receive the die pin 32 and, more specifically, receive the upper pin outer surface 36. The die pin 32 is coupled to the die rod 124 and is operationally movable within the cavity 53 to vary the gap 79 for profiling differential thicknesses of the parisan. During extrusion of the parisan, and to vary the gap 79, the die pin 32 moves relative to the receiver 52 with the inner receiver surface 54 sliding along the outer surface 36. The receiver 52 further includes a tapered outer receiver surface 56 that defines a portion of a pathway 24 along which the material flows in a molten state to the gap 79 where it is extruded to form the parisan. The gap 79 acts as the terminus of the pathway 24.

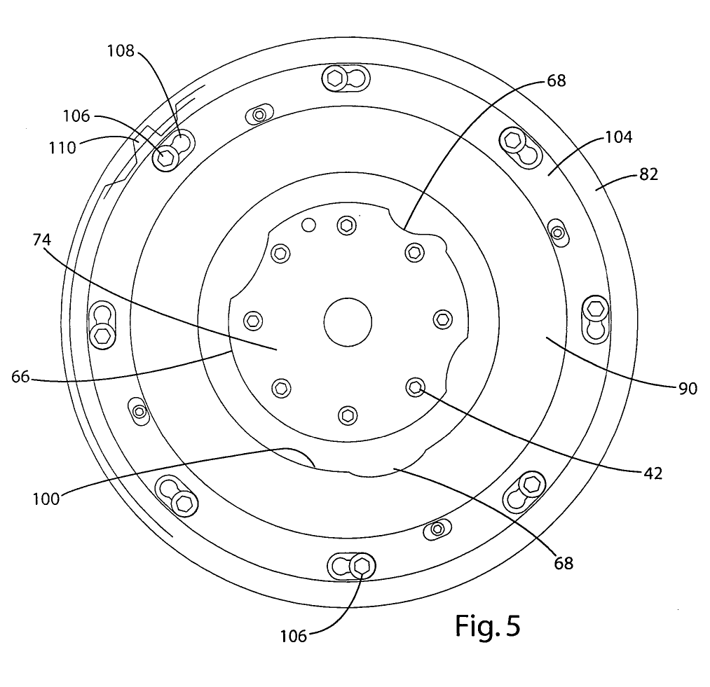

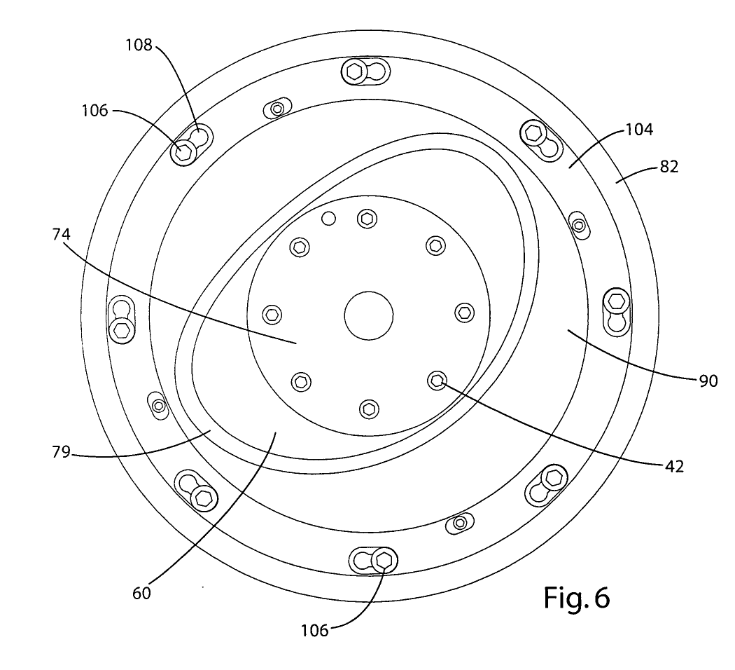

The inner assembly 50 includes an inner ring 60 and a cap 74. In the illustrated embodiment, the inner ring 60 is coupled to the die pin 32 with the cap 74. A lower pin fastener assembly 42 releasably couples the cap 74 to the die pin 32. The inner ring 60 generally includes, as illustrated in FIGS. 2-4, an inside surface 62 configured to receive the die pin 32 and align the inner ring 60 relative to the die pin 32 and a shaped surface 63. The shaped surface 63 further includes a top inner edge 64 and an extrusion edge 66. The inner ring 60 may be formed in a variety of sizes, shapes, and configurations, depending on the desired size, shape, diameter, and wall thickness of the extruded parisan. As illustrated in FIGS. 2 and 3, the inner ring 60, specifically the extrusion edge 66, may have different diameters which affect the diameter of the extruded parisan. As illustrated in FIGS. 2 and 3, depending upon the diameter of the extrusion edge 66, the shaped surface 63 may vary in shape and configuration because the diameter size and shape of the top inner edge 64 generally is consistent. More specifically, during changing of a tool head 20, the inner assembly 50, including the inner ring 60, are removed with the die pin 32 and receiver 52 remaining on the die assembly 10. Therefore, the top inner edge 64 which engages the receiver 52 or die pin 32 remains constant between different inner rings 60, as shown in FIGS. 2 and 3, while the shaped surface 63 and extrusion edge 66 may vary to form different extrusion shapes. More specifically, the top inner edge 64 remains constant because it mates with a portion of the die assembly that is not removed and therefore mates to form a smooth extrusion pathway. The top inner edge 64 is illustrated in FIGS. 2 and 3 as being aligned with the upper pin outer surface 36, although in some embodiments, the top inner edge 64 may be aligned with the tapered outer receiver surface 56, or configured to be extended within the cavity 53 of the receiver 52 (not illustrated), with the receiver 52 fitting partially over the inner ring 60, wherein the tapered surface 56 terminates approximately against the shaped surface 63. As illustrated in FIGS. 2 and 3, the top inner edge 64 is generally configured to provide a smooth transition between the receiver 52 and the inner ring 60. A smooth transition between the receiver 52 and inner ring 60 facilitates a smooth extrusion pathway 24. A smooth extrusion pathway 24 with minimal obstructions or obstacles helps the material flow through the pathway 24 to the gap 79 with minimal applied force. The inner shaped surface 63 and the inner extrusion edge 66 may have a variety of configurations of which exemplary embodiments are shown in FIGS. 5 and 6. The inner shaped surface 63 is generally dependent upon the relative shapes and sizes of the inner extrusion edge 66 and the top inner edge 64. The size and shape of the inner ring 60, specifically the inner extrusion edge 66, is generally set by the desired size, shape, and wall thickness of the extruded parisan. The inner extrusion edge 66 may further include scallops 68 as shown in FIG. 5, which may increase or decrease wall thicknesses in specified spots. As shown in the alternative embodiment in FIG. 6, the inner extrusion edge 66 may be formed in a non-cylindrical shape such as an elliptical or oblong shape.

The inner surface 62 of the inner ring 60 is configured to be installed and retained on the die pin 32 with minimal effort and alignment. The inside surface 62 is formed to engage the lower pin outer surface 38 to longitudinally and laterally align the inner ring 60 relative to the die pin 32. The inner ring 60 may also be rotationally aligned about the axis 11 using an inner key assembly 70. The inner key assembly 70 may be a slot on one of the inner ring 60 or die pin 32 into which a projection on the other of the inner ring 60 or die pin 32 slips into, as illustrated in FIG. 2.

In the illustrated embodiment, the inner ring 60 and the cap 74 are configured to allow easy installation and accurate alignment with minimal effort. As shown in FIG. 4, the cap 74 releasably attaches the inner ring 60 to the die pin 32 with the lower pin fastener assembly 42. The cap 74, as illustrated in FIGS. 5 and 6, includes a variety of fastener holes 76 which may be keyed, such as, the holes 76 in the cap 74 having a non-symmetrical orientation about the cap 74. In some embodiments, the cap fastener holes 76 may include key slots (not shown) which allow loosening of the bolts and removal of the cap 74 by twisting, without the need to fully remove the fastener assembly 42. Thereby, the inner ring 60 may be removed without complete removal of the lower pin fastener assembly 42. Using key slots allows for easier installation by allowing insertion of the inner ring and then securing the inner ring 60 with the cap 74 in an intermediate position without tightening the bolts of the lower pin fastener assembly 42. After the cap 74 is in the intermediate position, the lower pin fastener assembly 42 may be tightened.

The die assembly 10 further includes the die ring 82. The die ring 82 is attached to the blow molding machine by the die assembly retaining ring 122. The die ring 82 generally includes an inner surface 84 having an angled portion 86, a recessed portion 85, and a lower die ring edge 88. The die ring 82 further includes a die ring outer surface 83 for supporting and receiving heater coils 110 as described below. The die ring inner surface 84, specifically the recessed portion 85, is configured to receive, retain and align the outer assembly 80 relative to the die ring 82. The angled portion 86 defines a portion of the pathway 24 opposing the tapered outer receiver surface 56. The angled portion also includes a lower angled edge 87.

The outer assembly 80 generally is coupled to the die ring 82 and includes an outer ring 90 and a retaining ring 104 for securing the outer ring 90 to the die ring 82. The outer ring 90 generally includes an outer profiled surface 92 and an outer ring inner surface 96 having a top outer edge 98 and an outer extrusion edge 100. In the illustrated embodiment, the outer profiled surface 92 is profiled to mate with the lower die inner surface 84. The outer profiled surface 92 is configured to engage the die ring 82, specifically the lower die inner surface 84, and align the outer ring longitudinally along the axis 11. The outer ring 90 and die ring 82 further include an outer key assembly 94 to rotationally align the outer ring 90 about the axis 11 and relevant to the die ring 82 and the inner ring 60, as illustrated in FIG. 2. By aligning both the inner and outer rings 60, 90 about the axis with the inner and outer key assemblies 70, 94 the inner and outer rings 60, 90 may be easily aligned without the need for extensive adjustment. As with the inner ring 60, the outer ring 90 may be formed in a variety of sizes, shapes, and configurations to form the desired extruded parisan. More specifically, as shown in FIGS. 2 and 3, as the inner ring 60 increases in diameter, the outer ring 90 generally decreases. Further, the outer ring inner surface 96 depends on the relative diameter of the outer extrusion edge 100 and the shaped surface 63 of the inner ring 60 to provide a sufficient pathway 24.

In the illustrated embodiment, the outer ring 90 further includes a retention recess 93 for engaging the retaining ring 104. The retaining ring 104 holds the outer ring 90 to the die ring 82. The retaining ring 104 generally includes a plurality of key slots 108 and is attached to the die ring 82 through the retainer fastener assembly 106. The key slots 108 allow for easy removal of the retainer ring 104 and thereby the outer ring 90 by loosening the fastener assembly 106 and then rotating the retaining ring 104 relative to the die ring 82.

The heater coils or heater bands 110 are located on the die ring 82 surrounding the outer surface 83 so that the retaining ring 104 may be removed without removal of the heater bands 110. The heater bands 110 not engaging any of the removable tool head allows efficient changes of the tool head 20 without the need to remove the heater bands 110 and eliminating the need for a qualified tradesman in tool head 20 changes. As illustrated in FIGS. 2 and 3, the heater bands 110 do not engage any portions of the tool head 20 or any parts of the die assembly 10 that must be removed.

The above tool head 20, including the outer and inner assemblies 80, 50 uses minimal parts thereby minimizing the number of parts that need to be removed and reinstalled. In the illustrated embodiment, the tool head 20 includes only four parts, the inner ring 60, the outer ring 90, the cap 74 and the retaining ring 104, that are removed to change a tool head 20. The number of parts is reduced in formation of the die assembly 10 by eliminating a variety of pieces between the inner and outer rings, such as requiring the die ring 82 to include a recessed portion 85 into which the outer ring 90 fits without any intermediate parts. This elimination of parts minimizes the cost of the die assembly as well as the cost of individual tool heads. Further, the elimination of parts also minimizes assembly time by requiring fewer parts to be disassembled and reassembled in changing the tool head 20. The assembly time is further minimized by designing the die ring 82 and die pin 32 to engage the inner and outer rings 60, 90 in a specified lateral, longitudinal and rotational position that eliminates time consuming adjustments and any mechanisms required for adjusting and aligning the rings 60, 90 relative to each other. The retaining rings 104 and caps 74 are also designed for easy installation and removal. The elimination of parts, as well as minimizing the number of removable parts by designing the die assembly 10 and removable tool head 20 for easy removal also creates a relatively light weight tool head easily handled by one to two people without special lifts. Further, the inner and outer rings 60, 90 may be designed so that only one needs to be changed to switch between containers while maximizing performance.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A tool head for a blow molding machine comprising:
a die ring having a lower die edge, an outer die surface, and an inner die surface;
an outer ring having an outer profiled surface and a lower ring surface, wherein said outer profiled surface engages said inner die surface; and
a retaining ring engaging said lower die edge and said lower ring surface.

2. The tool head of claim 1 wherein said outer profiled surface is substantially a mirror image of said inner die surface.

3. The tool head of claim 1 further including a fastener assembly coupling said retaining ring to said die ring.

4. The tool head of claim 3 wherein said fastener assembly includes a plurality of bolts and said retaining ring includes a plurality of key hole slots allowing insertion and removal of said retaining ring from said die ring without complete removal of said plurality of bolts.

5. The tool head of claim 1 wherein said retaining ring couples said outer ring to said die ring.

6. The tool head of claim 1 wherein die ring and said outer ring include a key mechanism for rotationally locating said outer ring relative to said axis and wherein said outer ring fits at least partially within said die ring and at a set position relative to said die ring.

7. The tool head of claim 1 wherein said outer ring is self-aligning relative to said die ring.

8. The tool head of claim 1 further including at least one heater coil coupled to said die ring and wherein said retaining ring and said outer ring are removable from said die ring independent of said heater coil.

9. A tool head for a blow molding machine comprising:
a die ring;
an outer ring; and
at least one heater coil coupled to said die ring.

10. The tool head of claim 9 wherein die ring is substantially located between said heater coil and outer ring.

11. The tool head of claim 9 wherein said outer ring may be removed from said die ring without removing said heater coil.

12. The tool head of claim 11 further including a retaining ring coupled to said die ring with a fastener assembly, wherein said retaining ring couples said outer ring to said die ring and wherein said heater coil is located on said die ring adjacent to said retaining ring.

13. The tool head of claim 9 further including a retaining ring coupling said outer ring to said die ring, said retaining ring engaging a lower die surface of said die ring and a lower ring surface on said outer ring.

14. A tool head for a blow molding machine comprising:
a die ring;
an outer ring coupled to said die ring, said outer ring and said die ring including an outer key assembly, said outer key assembly rotationally aligning said outer ring with said die ring;
a die pin; and
an inner ring coupled to said die pin, said die pin and said inner ring including an inner key assembly, said inner key assembly rotationally aligning said inner ring relative to said outer ring, said inner ring and said outer ring defining an extrusion gap therebetween.

15. The tool head of claim 14 further including an axis and wherein said die ring includes a die ring inner surface configured to receive and engage said outer ring, said inner surface aligning said outer ring along said axis.

16. The tool head of claim 15 wherein said die ring inner surface aligns said outer ring longitudinally and laterally relative to said axis.

17. The tool head of claim 14 wherein said die pin includes a lower pin outer surface configured to receive and engage said inner ring and wherein said lower pin outer surface aligns said inner ring along said axis.

18. The tool head of claim 14 further includes an axis and wherein at least one of said inner and outer rings defines scallops and wherein said outer key assembly and said inner key assembly rotationally align said scallops about said axis.

19. The tool head of claim 14 wherein said outer assembly includes a key member and a slot for receiving said key member.
